(19) United States
(12) Patent Application Publication
(10) Pub. No.: US 2026/0094488 A1
(43) Pub. Date: Apr. 2, 2026

(54) Hybrid Dice-Based Gaming System for Determining A Gaming Outcome Based on Pseudo RNG-Based and Physics-Based Results

(71) Applicant: Aristocrat Technologies, Inc., Las Vegas, NV (US)

(72) Inventors: Joseph Masinter, II, Las Vegas, NV (US); Alfred Thomas, Las Vegas, NV (US); Shanon Nishimura, Nishimura, NV (US); Timothy Barbour, Nolensville, TN (US); Jehosua Josue, Las Vegas, NV (US); Stephen Shaffer, JR., Las Vegas, NV (US); Paul Barker, Chicago, IL (US); Xiaoqiang Gong, Henderson, NV (US); Frank Rodriguez, Las Vegas, NV (US)

(21) Appl. No.: 18/902,548

(22) Filed: Sep. 30, 2024

(51) Int. Cl. G07F 17/32

(52) U.S. Cl. CPC G07F 17/3211; G07F 17/3286

(57) ABSTRACT

A game instance outcome is determined for a hybrid game based on an RNG-based outcome and a physics-based outcome. The technique includes determining, based on a first random number generator specific to a local terminal, a first die outcome. In addition, an indication of a community die outcome for the local terminal and one or more additional terminals in a bank of terminals are received. The community die outcome is determined from sensing an outcome of a physical manipulation of the community die. A combination of the first die outcome and the community die outcome is applied to an outcome data structure to determine an outcome value for the game instance, and the outcome value for the game instance is presented on a display device.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player.

Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### SUMMARY

Techniques described herein are related to determining a hybrid game outcome. In response to initiating a game instance, determining, based on a first random number generator specific to a local terminal, a first die outcome is determined based on a first random number generator specific to a local terminal. In addition, an indication of a community die outcome for the local terminal and one or more additional terminals in a bank of terminals is received, where the community die outcome is determined from sensing an outcome of a physical manipulation of the community die. A combination of the first die outcome and the community die outcome is applied to an outcome data structure to determine an outcome value for the game instance; and presenting the outcome value for the game on a display device. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a system diagram of a bank of terminals in accordance with one or more embodiments.

FIG. 5 is a flowchart illustrating an exemplary method for determining a game outcome based on the combination of pseudo RNG-based and physics-based results, according to one embodiment of the present invention

FIG. 6 illustrates an example diagram of a system for determining a game instance outcome using physical and RNG-derived outcomes.

FIG. 7 depicts a system diagram for a hybrid community dice game, in accordance with a more embodiments.

### DETAILED DESCRIPTION

The disclosure is generally related to a hybrid dice-based system that relies on a combination of an RNG outcome and a physics-based outcome. In particular, the disclosure is related to a community dice game that determines a game outcome by combining results of two separate and distinct randomly driven events. The first event is the result one or more RNGs calls which are visually represented by one or more dice on a user interface of a terminal of the user. The second event is based on the result of four community dice. The community dice are manipulated for movement within a controlled space, allowed to come to rest in specific positions (physics-driven outcome), and the value of each community die is then read by the system and shared with each terminal of a bank of terminals. The value of each community die is combined with the RNG-driven value of the first event to create a user hand. The user hand is evaluated against a gaming outcome data structure, such as a pay table, to determine a game outcome.

According to one or more embodiments, the physics-driven outcome is based on an outcome of one or more community dice in a shared structure among the bank of terminals. The structure may include a physical agitator which is configured to trigger movement of the one or more community dice. The structure may also include one or more sensors, such as a camera or other optical reader, which is configured to determine an outcome of the community dice. The detected outcome is then translated to a digital representation and propagated to each terminal of the bank of terminals. Once the value of each community die has been established, each terminal may then generate a visual indication of the community dice outcome.

At the same time, a terminal-specific RNG can determine an outcome for one or more terminal specific dice. For example, an outcome of the RNG may be mapped to one or more terminal-specific dice outcomes. The one or more terminal-specific dice outcomes may then be visually represented at the user interface. Because the RNG-driven outcomes are specific to a particular terminal, two terminals that share the community dice may have different terminal-specific dice outcomes. In some embodiments, the terminal-specific RNG outcome may be determined before, after, or concurrently with the physical dice outcome. Further, the result of the terminal-specific RNG may be presented on the terminal before, after, or concurrently with the community dice outcome.

Once the outcome for the community dice and the terminal-specific dice have been determined, a hand for the particular terminal is determined based on the combination of outcomes. For example, the combined outcome can be compared against a pay table or other gaming outcome data structure to determine an outcome for the game. In addition, other side games can be provided based on the combined outcome and/or one or more additional RNG and/or physics-based outcomes.

Embodiments described herein provide a technical innovation by combining physical manipulation and digital integration to improve upon traditional electronic gaming machines. In addition, the use of physical dice for which an outcome is physics-based and shared with other terminals expands the ability of the electronic gaming machine by enhancing the number of combinations of outcomes and outsourcing some of the resources required to reach a result with a shared bank system among the terminals, thereby reducing compute and other resources

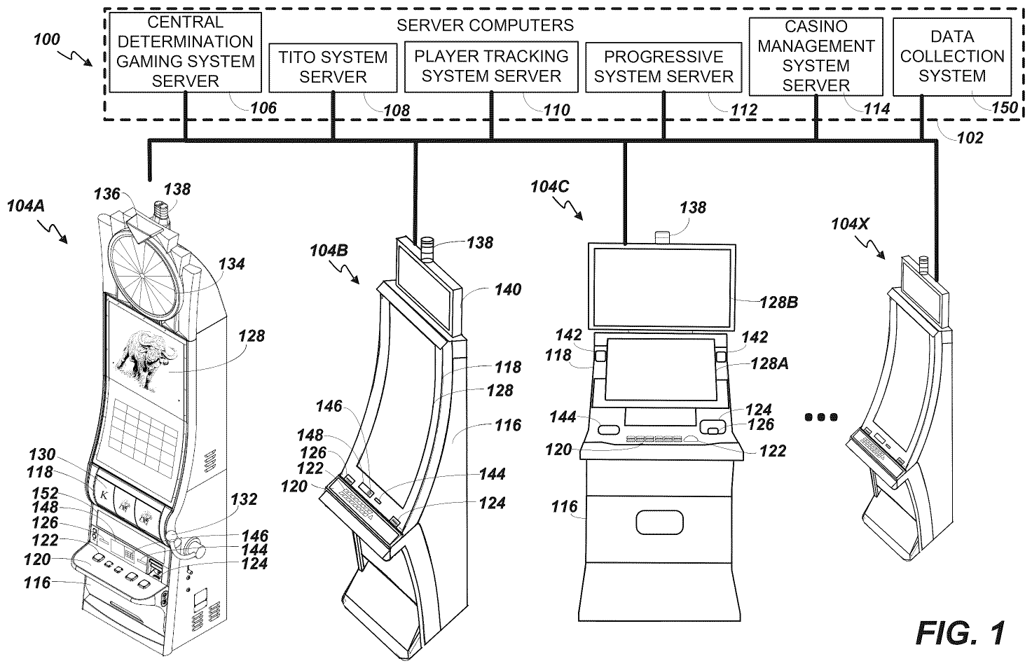

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, a casino management system server 114, and/or a data collection system 150. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

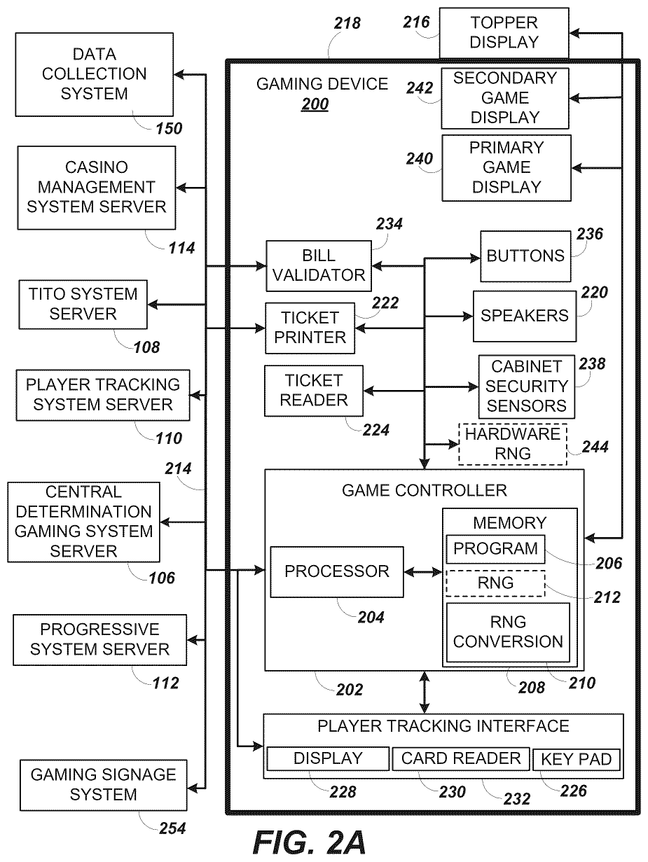

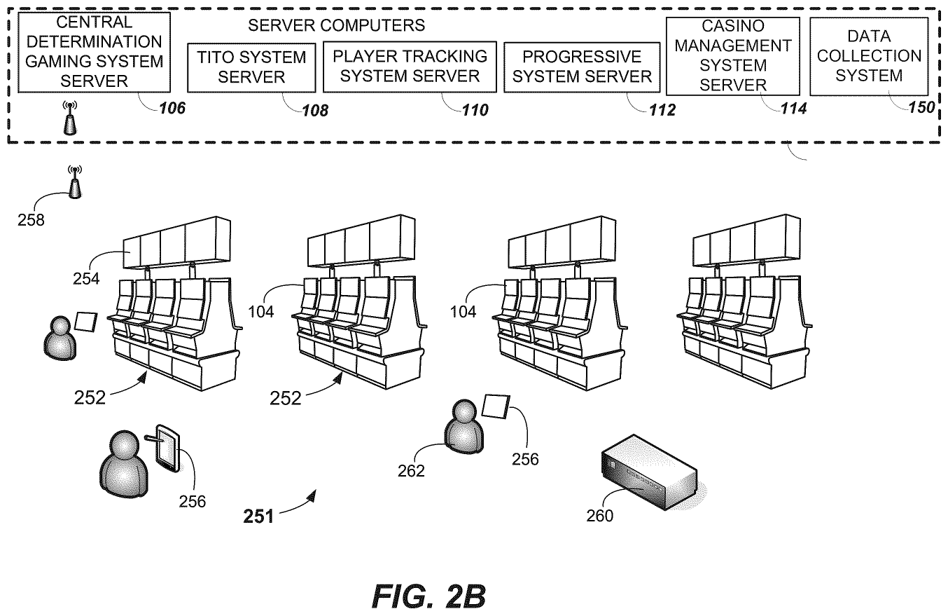

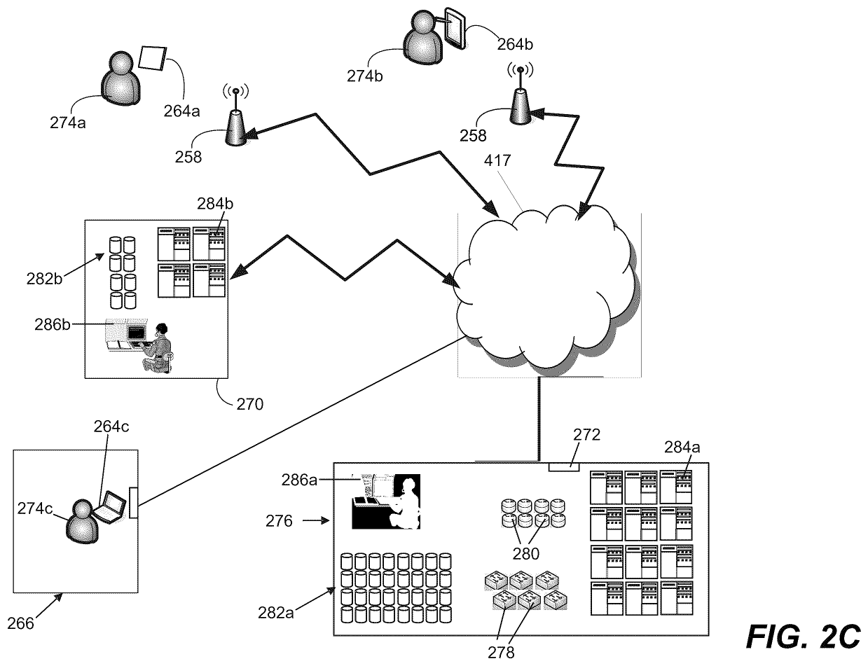

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify, and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system.

Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment, and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones, and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication.

Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

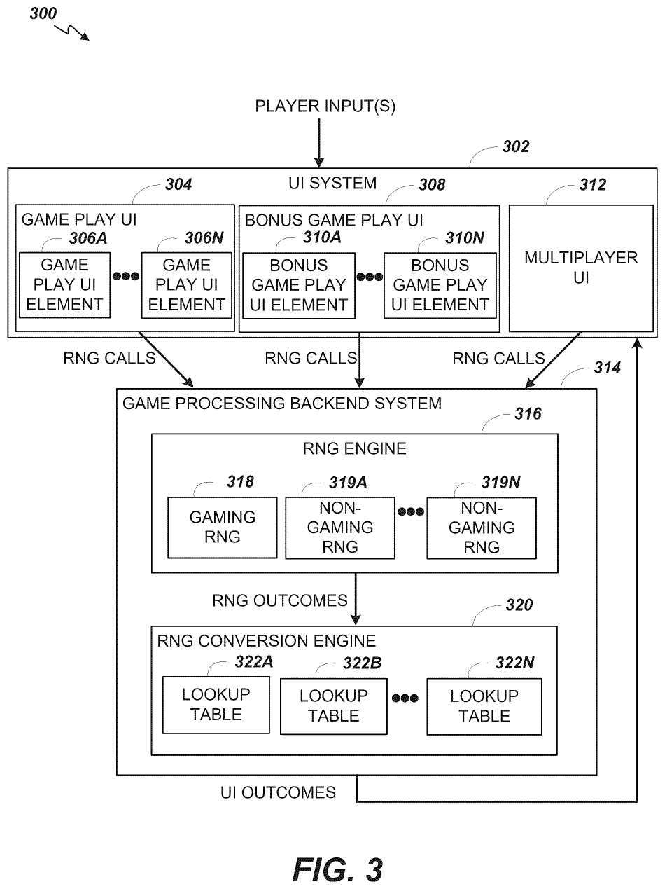

FIG. 3 illustrates, in block diagram form, an implementation of a game processing architecture 300 that implements a ga me processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1. Further, as described below, one or more additional outputs may be a community output shared among multiple gaming devices, such as a local gaming device and one or more remote gaming devices on a same bank. In some embodiments, the shared community output may be based on a physics-based random output and may or may not involve using an RNG.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more dice outcomes) are shown and/or made available to a user.

In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N. In some embodiments, the bonus game play UI may be presented concurrently with the game play UI 304. In addition, the bonus game play UI may correspond to side game features, which may be determined based on a same outcome as the base game.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

In some embodiments, the outcome may be based on additional inputs, along with the RNG outcome. For example, a physics-based community outcome may be received from a central system, for example a bank system comprising a physics-based dice system for which the outcome contributes to two or more gaming devices connected to the bank system. A combination outcome consisting of the community outcome and the RNG-based outcome may be mapped against a lookup table or other data structure to determine a game outcome.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

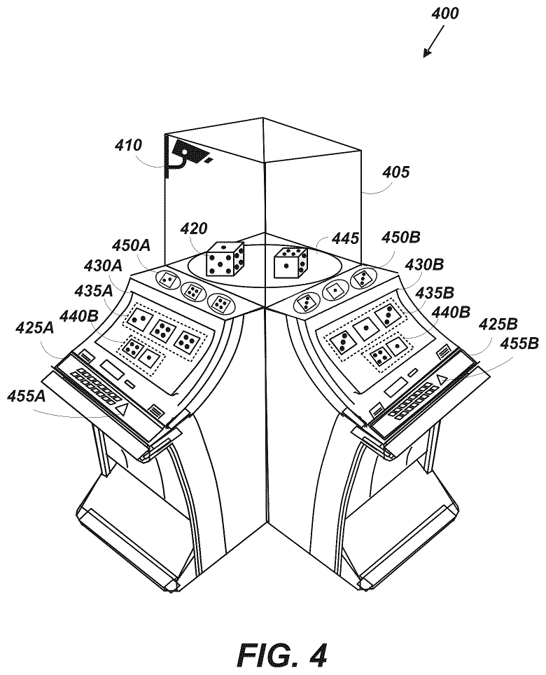

Turning to FIG. 4, an example system 400 is presented in which multiple EGMs use a shared physics-based outcome to determine individual game instance outcomes at the different terminals. In particular, the system 400 includes a bank of terminals arranged about an environment 405 containing dice 420, including terminal 425A and terminal 425B. The cabinets are both communicate coupled to a central bank system which can provide community outputs. The central bank system may include and enclose environment 405 in which a physics-based outcome can be determined. In this example, the physics-based outcome includes an outcome of a set of dice 420 when they come to rest. The dice 420 can be set in motion by a physical agitator 445, for example in response to one or more active terminals, such as electronic gaming machine 425A and electronic gaming machine 425B initiating a game instance. According to some embodiments, the game instance may be initiated when each participating EGM receives a user input to initiate the game instance. This may include, for example, activating a user input component on a user interface to initiate the instance. As another example, a user may interact with a physical input component, such as a button on the terminal 425A or 425B, to request initiation of the game instance. In addition, other participating EGMs may also detect activation of a user input component. In some embodiments, because the outcome of a game instance relies on the combination of a terminal-specific outcomes and a community outcome, a single terminal or central system can determine when to initiate the game instance based on input at the different EGMs.

Upon initiation of a game instance, each EGM will determine a terminal-specific outcome. The terminal specific outcome may be based on a RNG outcome for the particular terminal. For example, upon initiation of the game instance, an RNG for EGM 425A will generate a first outcome, whereas an RNG for EGM 425B will generate a second outcome. Because the EGMs are using different RNG, the results may be the same or may differ.

The result of the terminal-specific outcome may be determined by applying the RNG outcome to a data structure or lookup table, which maps the outcome to one or more die outcomes. The terminal specific outcome may then be presented in a first portion of a user interface on the respective terminal. In this example, EGM 425A includes a user interface 430A, with a terminal specific outcome portion 435A. As shown, the terminal-specific outcome includes dice outcomes of 2-4-4. By contrast, EGM 425B includes a user interface 430B with a terminal specific outcome portion 435B. As shown, the terminal specific outcome for terminal 425B includes dice outcome of 3-1-3. In some embodiments, the RNG-driven outcome may be reflected by physical dice on the cabinet. For example, the terminal-specific physical dice 450A reflect the RNG-based outcome of the roll as shown at terminal specific outcome portion 435A. The terminal-specific physical dice 450A may be incorporated into the cabinet 425A such that the terminal-specific physical dice 450A can be physically manipulated to reflect the RNG-outcome, for example by rotating into position.

In addition, initiation of the game instance may additionally trigger physical agitation of the community dice 420. For example, agitator 445 may be activated. According to one or more embodiments, the agitator may be triggered when a user presses a play button, such as play button 455A or play button 455B. The central system may include one or more sensors configured to determine an outcome of the community dice. This may include, for example, a motion detection sensor to determine when the community dice 420 have come to rest.

Additionally, alternatively, image data may be captured, for example by camera 410, to determine the outcome. That is, image data captured by camera 410 can be analyzed to determine whether the community dice 420 have come to rest, and/or to use detection techniques to determine an outcome of the community dice. The outcome can then be shared with each terminal participating in the game instance. In this example, the outcome of community dice 420 is 1-4. Accordingly, terminal 425A includes a community outcome portion 440A on the user interface 430A, showing a dice outcome of 1-4. Similarly, terminal 425B includes a community outcome portion 440B on the user interface 430B, also showing the community dice outcome of 1-4.

The game outcome for the same instance can be determined by applying a combined outcome to a pay table or other data structure configured to provide outcome data for a particular combination outcome. For example, the combined outcome for terminal 425A includes a dice roll of 2-4-4-4-1. By contrast, the combined outcome for terminal 425B includes a dice roll of 3-1-3-4-1. Each of these combined outcomes can be compared against the game outcome table, such as a pay table or other data structure, to determine an outcome for the game instance. The outcome for the game instance may then be presented on each of the terminals. The outcome for the game instance may be determined individually at each terminal. For example, each of terminal 425A and terminal 425B may include a memory for storage comprising the pay table or other data structure which can be referenced to determine the game outcome.

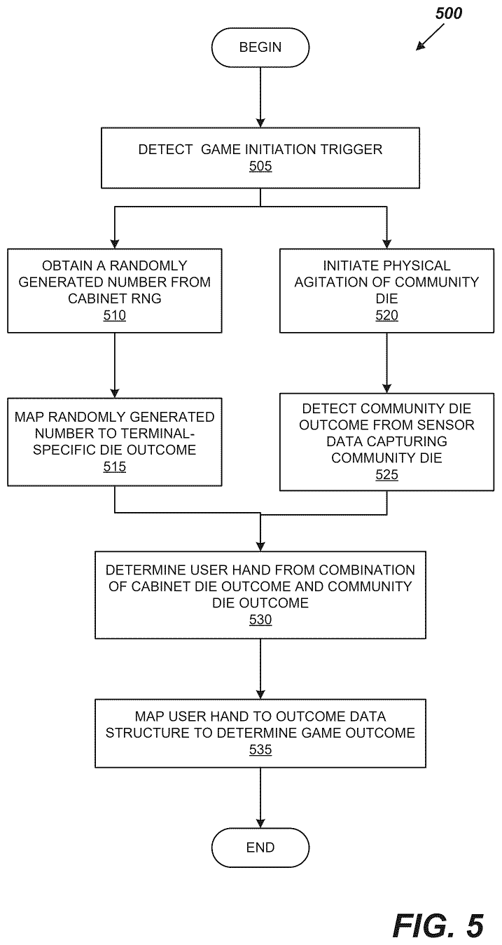

FIG. 5 is a flowchart illustrating an exemplary method for determining a game outcome based on the combination of pseudo RNG-based and physics-based results, according to one embodiment of the present invention. The technique may be performed by a gaming system comprising a plurality of gaming terminals for EGMs connected by a terminal system having a community die enclosure having a plurality of community dice and a detector for reading the values of the community dice.

The flowchart 500 begins at block 505, where the gaming system detects a game initiation trigger from one or more of the gaming terminals. The game initiation trigger may be, for example, a user input on a user interface of one or more of the terminals, such as pressing a play button or placing a wager on one or more of the game options. In some embodiments, the game initiation trigger may be based on a combination of inputs from different terminals. For example, the triggering condition may be determining that all active terminals in the bank have requested initiation of the game instance, or otherwise indicated that the terminal is not participating in the game instance. Because the initiation trigger may rely on input from multiple terminals, a particular game terminal, or the bank system, may be tasked with determining whether the initiation trigger is satisfied.

At block 510, each active terminal obtains a randomly generated number from a random number generator (RNG) engine, such as RNG engine 316 of FIG. 3. The randomly generated number may be used to determine the values of one or more cabinet dice for each gaming terminal. For example, the RNG outcome may be mapped against a die or dice outcome in a lookup table or other data structure. The terminal-specific dice outcome can then be represented by the cabinet. In some embodiments, a digital representation of the terminal-specific dice outcome may be presented on a user interface of the terminal. Additionally, or alternatively, the terminal-specific dice outcome may be represented by the cabinet physically manipulating physical dice on the cabinet to reflect the RNG-driven outcome. The cabinet dice may be physical dice that are manipulated by a cabinet die mechanism within the gaming terminal, or virtual dice that are displayed on the user interface.

The flowchart 500 proceeds to block 515, where the EGM maps the randomly generated number to the terminal-specific die or dice outcome. The mapping may include converting the randomly generated number to a corresponding value for each of the terminal-specific dice, based on a lookup table or other suitable data structure. The mapping may also include displaying the cabinet die outcome on the user interface of the gaming terminal as virtual dice. In some embodiments, the terminal may include physical dice which can be manipulated to rotate such that the physical dice mirror the outcome of the RNG-derived outcome. In some embodiments, the mapping and subsequent display of dice values may be performed at each terminal participating in a game instance with a common community die enclosure.

As discussed above the game initiation trigger may be, for example, a user input on a user interface of one or more of the terminals, such as pressing a play button. Returning to block 505, once the game instance is initiated, the flowchart 500 also proceeds to block 520. At block 520, the terminal system initiates physical agitation of the community die or dice within the community die enclosure to initiate movement of the dice. The community die enclosure may be located at a central location that is visible to all the gaming terminals, or at another suitable location. The community die enclosure may include a transparent or semi-transparent display on at least some sides in front of the terminals that can show game content, such as a game status, a jackpot amount, or other information. Accordingly, the physical community dice may be visible through the display. The community dice may include dice that have numerical values from one to six. In some embodiments, variations of the dice may be included. In some embodiments, the dice may include a multiplier die that has multiplier values on each face, for example from one to six. The community dice may be located on an agitator, such as agitator 445 of FIG. 4, which is configured to spin, fling, pop, or otherwise initiate motion of the community dice within the community die enclosure. The agitator may be controlled by a motor, a disk, and/or other components. The agitator will cause the community dice to move about the community dice enclosure for a predetermined time while the agitator is active. After a predetermined time interval, the agitator will deactivate. The community dice may continue movement for a brief time after the agitator has deactivated and eventually come to rest under their own weight within the community dice enclosure. Alternatively, the play button (455) of one or more terminals which is used as a game initiation trigger to trigger steps 510 and 520 may serve an additional function of controlling a duration during which the agitator is actively effecting movement of the community dice. Specifically, rather than depressing the play button of a terminal as a triggering event to agitate the community dice in the community dice enclosure, the play button may be depressed and held to a depressed position during which time the agitator will be active. Once the play button has been released at one of the gaming terminals the agitator may be deactivated resulted in movement of the community dice ceasing. Having the agitator controlled by one or more of the terminals via the play button gives a user of the terminal the impression that they have some control or that skill may be involved in the eventual rest position of the community dice.

In some embodiments, because the agitator and community dice are shared among multiple players and terminals, the particular terminal controlling the community dice and, thus, agitator may differ. In some embodiments, terminals may take turns controlling the activation of the agitator. Alternatively, a most recent winner may be allowed to trigger the agitator. Still other variations may be used to determine which terminal controls the agitator for a particular game instance.

The flowchart proceeds to block 525, where the bank system detects the community die outcome from the sensor data capturing the community die enclosure. The sensor data may be obtained by a detector that is configured to read the values of the community dice after they come to rest within the community die enclosure. The detector may include an optical reader, an RFID reader, a camera, or another suitable device that can identify the values of the community dice and their rest position within the community die enclosure. The sensor data and/or detected values of the community dice may be transmitted to a central server, to each gaming terminal, or to another suitable location. According to some embodiments, the community die outcome may be presented on a terminal user interface. For example, a rendering of a bird's eye view of the community die outcome may be presented on the user interface of each gaming terminal, either as a live video feed or as an animation. The mapping may further include displaying a bird's eye view of the community die outcome on the user interface of each gaming terminal, either as a live video feed or as an animation.

At block 530, the terminal determines a user hand from a combination of the terminal-specific die outcome and the community die outcome. The user hand may include a set of dice values, comprising the values of the dice in the community die outcome and the terminal-specific die outcome. The user hand may also include a multiplier value, comprising a multiplier die value, for example from the community die outcome. The user hand may be displayed on the user interface of each gaming terminal, either as a sequence of dice or as another suitable representation. In some embodiments, the user hand may be represented on the user interface separately from a terminal-specific outcome and/or the community die outcome. In some embodiments, the terminal-specific outcome and the community die outcome may be merged on the user interface to indicate the user hand.

The flowchart 500 concludes at block 535, where the terminal maps the user hand to an outcome data structure to determine a game outcome. The outcome data structure may include a pay table that specifies the payouts for different combinations of dice values, such as five of a kind, four of a kind, full house, straight, or three of a kind. The mapping may include comparing the user hand to the pay table and identifying any winning combinations. The mapping may also include applying the multiplier value to the payouts for any winning combinations. The mapping may further include displaying the game outcome on the user interface of each gaming terminal, either as an award amount, a message, an animation, or another suitable indication. In some embodiments, the mapping may occur at each terminal, based on the user hand at the particular terminal. The gaming system may also reset the community dice and/or the cabinet dice for the next game, and may receive another game initiation trigger from one or more of the gaming terminals.

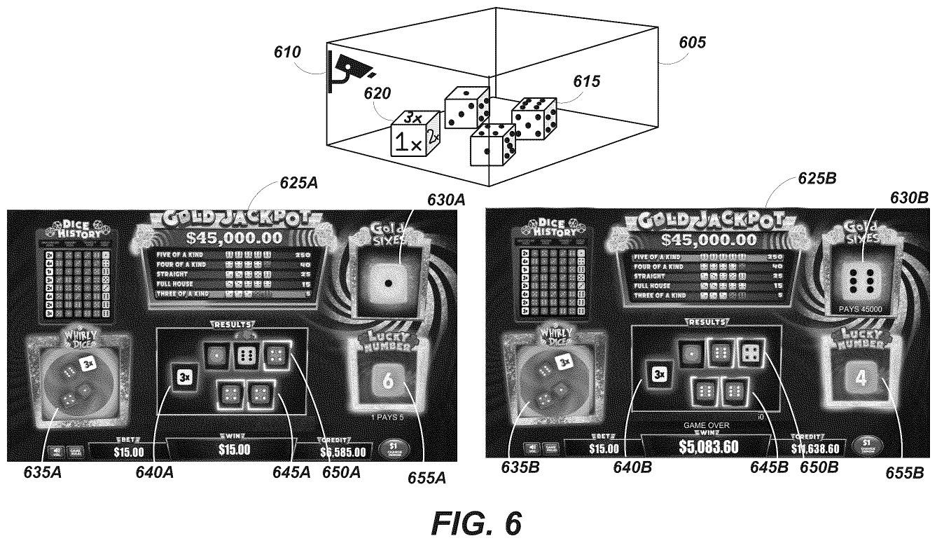

FIG. 6 illustrates an example diagram of a system for determining a game instance outcome using physical and RNG-derived outcomes. In particular, FIG. 6 shows an example system setup of a community dice enclosure 605 and two graphical user interfaces 625A and 625B associated with different terminals that share the community dice enclosure 605. The community dice enclosure 605 is a controlled environment in which a set of dice are physically manipulated to generate a random outcome for a dice-based game. In the example shown, the set of dice includes one or more numeric dice 615 and one or more multiplier dice 620. The numeric dice 615 have faces marked with numbers from one to six, and the multiplier dice 620 have faces marked with multiplier factors, such as 1×, 2×, 3×, and the like. In the example shown, the community dice enclosure 605 may include a mechanical agitator (not shown) that rotates, vibrates, or otherwise moves the dice within the enclosure 605. Alternatively, the community dice enclosure 605 may include an air blower (not shown) that blows air into the enclosure 605 to cause the dice to tumble and bounce, or other component which, when activated, is configured to initiate motion of the dice within the enclosure 605. The community dice enclosure 605 may also include a transparent or semi-transparent display (not shown) on one or more terminal-facing surfaces of the enclosure 605. The display may be configured to display game information, such as game rules, pay tables, or promotional content.

The outcome of the agitation of the dice is determined by one or more sensors that detect the upward facing values of the dice when they come to rest within the enclosure 605. An example sensor is a camera 610 that is positioned above the enclosure 605 and captures an image of the dice. The camera 610 may be connected to a computing device or controller that processes the image or other data, and identifies the values of the numeric dice 615 and the multiplier die 620. Alternatively, the sensor may be an optical reader, an RFID reader, or any other suitable device that can read the values of the dice. In other embodiments, the sensor may be a positional sensor within each of the dice which can indicate when the dice have come to rest, and an orientation of the dice. The outcome of each of the dice may be determined based on a mapping between the positional sensor data and the value on the upward face of the dice, for example in software or electronic storage.

The outcome of the numeric dice 615 and the multiplier die 620 are presented on the graphical user interfaces 625A and 625B of the terminals that are communicably coupled to the bank system. The graphical user interface 625A shows an example of an interface at a first terminal, and the graphical user interface 625B shows an example of an interface at a second terminal. The two terminals may be part of a bank of terminals that are arranged around the community dice enclosure 605. The graphical user interfaces 625A and 625B may be display devices, such as touchscreens, LCDs, LEDs, or any other suitable devices that can display game information and receive user input. The graphical user interfaces 625A and 625B may also include physical or virtual buttons, such as play buttons, bet buttons, or selection buttons, which allow the users to interact with the game.

The graphical user interface 625A includes a community dice area 635A that shows a graphical representation of the outcome of the numeric dice 615 and the multiplier die 620 from the community dice enclosure 605. The community dice area 635A may display a bird's eye view of a representation of the dice within the enclosure 605, thereby showing the values of the result of the agitation. The community dice area 635A may also display a message area (not shown) that indicates the values of the community dice or the status of the agitation. Similarly, the graphical user interface 625B may include a community dice area 635B showing the same graphical representation of the outcome of the numeric dice 615 and the multiplier die 620 from the community dice enclosure 605.

The graphical user interface 625A includes a community result area 650A that shows the outcome of the numeric community dice 615. The community result area 650A may display the values of the numeric community dice 615 as numbers, symbols, or graphics. The graphical user interface 625A also includes a multiplier area 640A that shows the outcome of the multiplier die 620. The multiplier area 640A may display the value of the multiplier die 620 as a number, a symbol, or a graphic. The multiplier area 640A may also highlight or animate the multiplier die 620 that applies to the win. Similarly, the graphical user interface 625B includes a community result area 650B that shows the outcome of the numeric community dice 615, and a multiplier area 640B that shows the outcome of the multiplier die 620.

The graphical user interface 625A includes a terminal-specific result area 645A that shows the outcome of the RNG-driven outcome in the form of digital dice in the terminal-specific result area 645A. The terminal-specific result area 645A may display the values of the digital dice as numbers, symbols, or graphics. Similarly, the graphical user interface 625B includes a terminal-specific result area 645B that shows the RNG-driven outcome mapped to digital dice.

In some embodiments, the graphical user interfaces 625A and 625B may highlight or animate the digital representation of numeric dice that form a winning combination, such as a pair, a three of a kind, a four of a kind, a five of a kind, or a straight. The user interface may also display a message area (not shown) that indicates the amount of the win or the type of the win.

According to some embodiments, the user interfaces 625A and 625B may support one or more side games which can also rely on the hybrid outcome. The graphical user interface 625A includes a golden die 630A that shows a graphical representation of a golden die for a side game called Golden Sixes. The golden die is a virtual die that is generated by a random number generator (RNG) specific to the first terminal. The RNG may be a different RNG than the RNG used to determine the terminal-specific results shown at terminal-specific result area 645A. The golden die has faces marked with numbers from one to six, and the value of the golden die is determined by the RNG at the start of each game. The golden die 630A may display the value of the golden die as a number, a symbol, or a graphic. The golden die 630A may also highlight or animate the golden die when it matches the value of six. According to some embodiments the side game of Golden Sixes awards a jackpot if the user gets six of a kind. That is, if the golden die 630A, the three numeric community dice 650A, and the two terminal-specific dice in terminal-specific result area 645A are all a same value, then a jackpot is awarded as an outcome of the side game. Similarly, the graphical user interface 625B may include a golden die 630B for which a value is determined by an RNG for the second terminal. If the golden die 630B, the three numeric community dice 650B, and the two terminal-specific dice 645B are all a same value, then a jackpot is awarded as an outcome of the side game The user may place a separate bet on the side game of Golden Sixes before each game. The outcome of the Golden Sixes side game may be independent of the main game and may not affect the outcome or the payout of the main game.

The graphical user interface 625A also includes a lucky number area 655A that shows a graphical representation of a lucky number for another side game called Lucky Number. The lucky number is a number selected by the user from one to six before each game. For example, the lucky number area 655A may be a user-selectable component which can be manipulated by a user to adjust the lucky number. In some embodiments, the lucky number may alternatively be randomly assigned, for example by a random number generator for the terminal. The random number generator may be a same or different random number generator than the random number generator used for the terminal-specific outcome and/or the gold sixes outcome. The lucky number area 655A may display the lucky number as a number, a symbol, or a graphic. The lucky number area 655A may also highlight or animate the lucky number when it matches the value of any of the numeric community dice 615 or the terminal-specific dice 620. The lucky number area 655A may also display a message area (not shown) that indicates the amount of the win or the status of the side game. The user may place a separate bet on the side game of Lucky Number before each game. The side game of Lucky Number may be independent of the main game and the side game of Golden Sixes and may not affect the outcome or the payout of the other games.

The graphical user interfaces 625A and 625B may also include other features, such as a credit meter, a win meter, a bet meter, a denomination selector, a pay table button, a help button, a volume button, a service button, a cash out button, or any other suitable features that are common in gaming machines. The graphical user interfaces 625A and 625B may also include different colors, shapes, sizes, fonts, animations, sounds, or effects to enhance the visual appeal and the user experience of the game.

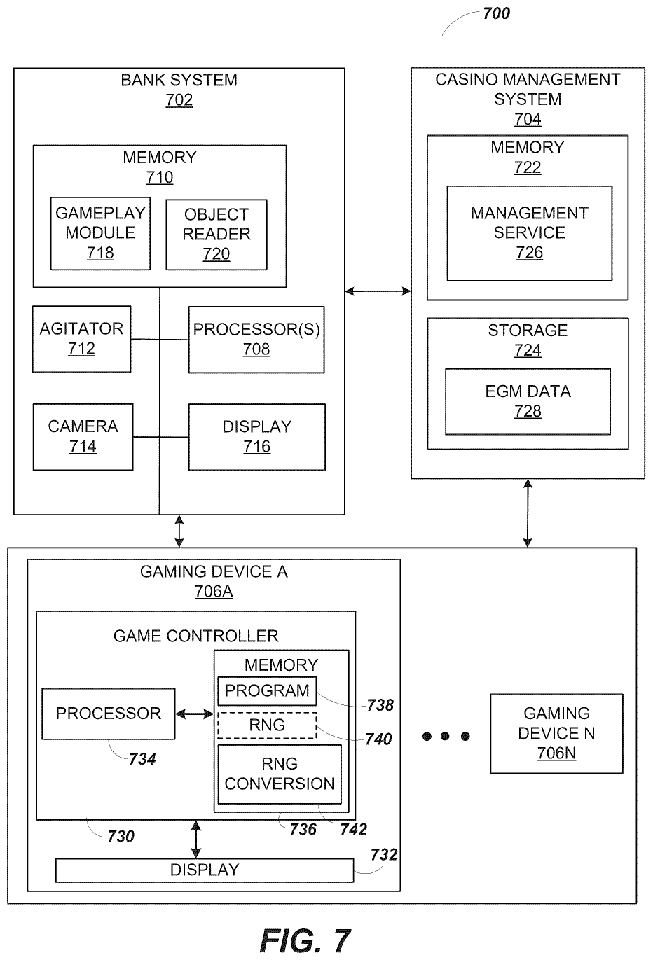

FIG. 7 depicts a system diagram for a hybrid community dice game, in accordance with more embodiments. In particular, FIG. 7 depicts a casino management system (CMS) 704 communicably coupled to a bank system 702 and a set of gaming device 706A-706N.

According to one or more embodiments, CMS 704, may include one or more servers. CMS 704 may be configured to store live gaming data related to the games. In some embodiments, the live data may include EGM data 728. Additionally, CMS 704 may be used to manage community games by configured to provide support for games within a casino using management service 726 in memory 722. CMS 704 may be coupled to a set of gaming devices 706A-706N. Gaming devices 706A-706N may be aligned in banks of similar devices for placement and operation on a casino floor.

According to some embodiments, the bank in which the gaming devices are connected may be associated with a bank system 702. In some embodiments, the bank system may provide functionality for providing a community outcome used by the gaming devices 706A-706N. The bank system may include a memory 710 including computer readable code for computational modules executable by one or more processor(s) 708. The computational modules may include a gameplay module 718. According to one or more embodiments, the gameplay module 718 may be configured to determine whether a game instance initiation parameter is satisfied based on status information for the gaming device 706A-706N. In some embodiments, the gameplay module 718 may then cause the agitator 712 to initiate motion of a set of community dice in an enclosure. The gameplay module 718 may determine when the dice have come to rest. For example, one or more sensors, such as camera 714, and/or other motion or visual sensors may be used to determine whether the position of the dice have stabilized. When the dice have stabilized, then an object reader 720 will be used to determine an outcome of the agitation. In some embodiments, the object reader may collect image data or other sensor data from a sensor capturing the enclosure, such as camera 714. The sensor data is then used to determine the values on a top surface of each of the dice. In some embodiments, the bank system 702 may also include a transparent or semi-transparent display 716, through which the physical dice are visible, and which is configured to present gaming data, such as a game status, jackpot information, or other data related to the game and/or the casino.

When a game instance is initiated, each of gaming device A 706A to gaming device N 706N may generate a random number, for example by a program 738 for the game making a call to an RNG engine 740 to generate one or more RNG outcomes. The RNG outcomes are then sent to the RNG conversion engine 742 to generate one or more terminal-specific outcomes. The terminal-specific outcomes are then combined with the community outcome determined from the object reader at the bank system 702. The combination outcome can then be compared against a pay table or other outcome data structure to determine an outcome for the game instance for each terminal. In some embodiments, each gaming device A 706A-706N may perform the lookup individually on device to determine a game instance outcome. Alternatively, the terminal-specific outcome and the community outcome may be passed to another device, such as bank system 702 or CMS 704 for an outcome determination for each gaming device.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A method comprising:
in response to initiating a game instance:
determining, based on a first random number generator specific to a local terminal, a first die outcome;
receiving an indication of a community die outcome for the local terminal and one or more additional terminals in a bank of terminals, wherein the community die outcome is determined from sensing an outcome of a physical manipulation of the community die; and
applying a combination of the first die outcome and the community die outcome to an outcome data structure to determine an outcome value for the game instance; and
presenting the outcome value for the game instance on a display device.

2. The method of claim 1, wherein the first die outcome comprises a first set of values for a first set of dice.

3. The method of claim 1, wherein the community die outcome comprises at least one numeric die and at least one multiplier die.

4. The method of claim 1, wherein the physical manipulation of the community die is performed by a mechanical agitator in a controlled environment within the bank of terminals.

5. The method of claim 1, further comprising: presenting a digital representation of the community die outcome on a user interface.

6. The method of claim 1, further comprising, in response to initiating the game instance:
determining, based on a second random number generator specific to the local terminal, a second die outcome,
wherein the second die outcome corresponds to a side game, and
wherein an outcome of the side game is determined based on the second die outcome and the combination of the first die outcome and the community die outcome.

7. The method of claim 1, further comprising:
determining, among the combination of the first die outcome and the community die outcome, a number of dice depicting a user-selected value; and
determining a side game outcome based on the number of dice depicting the user-selected value.

8. A non-transitory computer readable medium comprising computer readable code executable by one or more processors to, in response to initiating a game instance:
determine based on a first random number generator specific to a local terminal, a first die outcome;
receive an indication of a community die outcome for the local terminal and one or more additional terminals in a bank of terminals, wherein the community die outcome is determined from sensing an outcome of a physical manipulation of the community die; and
apply a combination of the first die outcome and the community die outcome to an outcome data structure to determine an outcome value for the game instance; and
present the outcome value for the game instance on a display device.

9. The non-transitory computer readable medium of claim 8, wherein the first die outcome comprises a first set of values for a first set of dice.

10. The non-transitory computer readable medium of claim 8, wherein the community die outcome comprises at least one numeric die and at least one multiplier die.

11. The non-transitory computer readable medium of claim 8, wherein the physical manipulation of the community die is performed by a mechanical agitator in a controlled environment within the bank of terminals.

12. The non-transitory computer readable medium of claim 8, further comprising computer readable code to:
present a digital representation of the community die outcome on a user interface.

13. The non-transitory computer readable medium of claim 8, further comprising computer readable code to, in response to initiating the game instance:
determine, based on a second random number generator specific to the local terminal, a second die outcome,
wherein the second die outcome corresponds to a side game, and
wherein an outcome of the side game is determined based on the second die outcome and the combination of the first die outcome and the community die outcome.

14. The non-transitory computer readable medium of claim 8, further comprising computer readable code to:
determine, among the combination of the first die outcome and the community die outcome, a number of dice depicting a user-selected value; and
determine a side game outcome based on the number of dice depicting the user-selected value.

15. A system comprising:
one or more processors; and
one or more computer readable media comprising computer readable code executable by the one or more processors to, in response to initiating a game instance:
determine based on a first random number generator specific to a local terminal, a first die outcome;
receive an indication of a community die outcome for the local terminal and one or more additional terminals in a bank of terminals, wherein the community die outcome is determined from sensing an outcome of a physical manipulation of the community die; and
apply a combination of the first die outcome and the community die outcome to an outcome data structure to determine an outcome value for the game instance; and
present the outcome value for the game instance on a display device.

16. The system of claim 15, wherein the first die outcome comprises a first set of values for a first set of dice.

17. The system of claim 15, wherein the physical manipulation of the community die is performed by a mechanical agitator in a controlled environment within the bank of terminals.

18. The system of claim 15, further comprising computer readable code to:
present a digital representation of the community die outcome on a user interface.

19. The system of claim 15, further comprising computer readable code to, in response to initiating the game instance:
determine, based on a second random number generator specific to the local terminal, a second die outcome,
wherein the second die outcome corresponds to a side game, and
wherein an outcome of the side game is determined based on the second die outcome and the combination of the first die outcome and the community die outcome.

20. The system of claim 15, further comprising computer readable code to:
determine, among the combination of the first die outcome and the community die outcome, a number of dice depicting a user-selected value; and
determine a side game outcome based on the number of dice depicting the user-selected value.
